(19) United States
(12) Patent Application Publication
(10) Pub. No.: US 2020/0222951 A1
(43) Pub. Date: Jul. 16, 2020

(54) APPARATUS, SYSTEM AND METHOD FOR REMOVING SOLIDS FROM A VESSEL

(71) Applicant: CEDA Services and Projects LP, Calgary (CA)

(72) Inventors: Martin Allen Heitkoetter, Beaumont (CA); Shay Odin Jarvis, Sherwood Park (CA)

(21) Appl. No.: 16/740,239

(22) Filed: Jan. 10, 2020

Related U.S. Application Data
(60) Provisional application No. 62/791,434, filed on Jan. 11, 2019.

(51) Int. Cl. B08B 9/08; B01D 21/24; B08B 7/02; B08B 7/04

(52) U.S. Cl. CPC B08B 9/0813; B08B 7/04; B08B 7/02; B01D 21/2472

(57) ABSTRACT

An apparatus, system and method for removing solids from a vessel, such as sand in the bottom of a heavy oil production storage tank used in a SAGD or CHOPS production application, in which the solids are fluidized and pumped out of the vessel using the same tank opening. A pipe or stinger is configured for insertion into a vessel, adjacent or into the solids to be removed, the stinger comprising a water injection conduit, a fluidized materials removal conduit, and a vibrating member. Water is injected through the stinger while the vibrating member imparts vibration to the solids, thus fluidizing the solids, and the fluidized solids are then removed through the fluidized materials removal conduit of the stinger.

### FIELD OF THE INVENTION

The present invention relates to solids removal from vessels, and more specifically to removal of produced solids such as sand in the bottom of a heavy oil production storage tank in a SAGD or CHOPS production application.

### BACKGROUND OF THE INVENTION

It is known that production tanks used in hydrocarbon production systems such as cold heavy oil production (CHOPS) or steam-assisted gravity drainage (SAGD) operations are susceptible to build-up of solids including sand. The sand is produced from the subsurface reservoir along with water and hydrocarbon as part of an emulsion, and the sand settles out in the bottom of the surface production tank. As the accumulation increases, vessel capacity decreases and negatively impacts productivity. Various methods for addressing this challenge are in commercial use, or have been considered for use, but in most cases the costs are either prohibitive or the effectiveness is limited.

One commonly employed method involves attaching a tee fitting to the exterior tie-in point of the tank. The vertical tie-in point of the tee is connected to a vacuum truck, and the horizontal portion of the tee, containing a packing gland, then has a high-pressure lance inserted into it which is connected to a pressure truck. Water from the pressure truck is then injected into the sand layer of the tank, and the high-pressure lance is then moved from one side of the tank to the other in order to slurry the sand, while the vacuum truck pulls on the now slurried sand. When the vacuum truck has reached its loading capacity, it then raises its tank and lets the water settle out. When the vacuum truck operator believes enough time has passed, and sufficient settling of the sand has occurred, the vacuum truck operator then pulls the settled-out water from the tank using the high line of the vacuum truck and sends the water back into the same or another tank. This process is repeated until such time as the operator feels that a sufficient load of sand has been brought onto the unit. When the first vacuum truck is at full capacity it will be driven to the disposal site and a second vacuum truck will continue emptying the tank. Once the tank is emptied of solids, the crew would then rig out, and the second vacuum truck would transport the load for disposal. This method of de-sanding, however, is highly dependent on the skill of the operator to produce a desired sand-to-water ratio for the load that will be sent to disposal, and results will vary significantly, sometimes as low as 50/50 (sand/water) going to disposal. This significantly increases the cost per unit volume of disposal load, in addition to ongoing variable operational costs.

Numerous other approaches have been attempted in conjunction with the current preferred method, such as sloped tanks, centrifuges, disk stacks, in-line filters and filter presses. Although much of this alternative technology has been proven for this use, and is typically known to produce greater results in dewatering the sand, the cost per unit volume impact through the use of such added technology is cost prohibitive.

What is needed, therefore, is a relatively simple and more cost-effective method for removing sand from production vessels, with reduced water volume in the disposal load.

### SUMMARY OF THE INVENTION

The present invention therefore seeks to provide an apparatus, system and method for extracting sand from a production tank, involving injecting a controlled volume of water while vibrating the accumulated solids to liquefy the solids to enable extraction. Due to the use of vibration, it is believed that less injected water is required to liquefy the solids layer for extraction.

According to one broad aspect of the present invention, there is provided a pipe configured for insertion into a tank to liquefy and remove solids from the tank, the pipe comprising:
a water injection conduit;
a vibrating member configured to impart vibration to the solids, the vibrating member comprising a vibrating head and an energy transfer member, the energy transfer member positioned within the water injection conduit while allowing water to flow around an exterior surface of the energy transfer member, the vibrating head configured for insertion into the solids; and
a fluidized materials removal conduit.

The fluidized materials removal conduit is preferably that portion of the pipe interior that lies outside the water injection conduit.

The energy transfer member is preferably a flexible shaft that is rotated, the flexible shaft contained within a protective jacket. Rotation of the shaft may be achieved by electric or hydraulic means, which means may be provided by a positioning implement such as a mini-track loader or other mechanical delivery means. An end of the flexible shaft, the vibrator head, preferably extends beyond the terminus of the water injection conduit in order to impart vibration to the solids layer in which the pipe is inserted.

According to a second broad aspect of the present invention, there is provided a system for disposal of produced solids, comprising:
a vessel for receiving the solids;
a pipe in fluid communication with the solids via a vessel inlet;
a water source for providing water to the pipe for injection into the vessel interior to form a water-solids slurry;
vibration means positioned within the pipe and configured to impart vibration to and liquefy the water-solids slurry; and
vacuum means for extracting the liquefied water-solids slurry through the pipe.

According to a third broad aspect of the present invention, there is provided a method for extracting solids from a vessel, comprising the steps of:
inserting a pipe into the vessel interior until a terminal end of the pipe is within or adjacent the solids;
injecting water through the pipe into the solids to form a water-solids slurry;
imparting vibration to the water-solids slurry to liquefy the water-solids slurry; and
extracting the liquefied water-solids slurry through the pipe.

Other aspects of the present invention, of broader or narrower scope, will be evident from the exemplary embodiments described herein.

A detailed description of an exemplary embodiment of the present invention is given in the following. It is to be understood, however, that the invention is not to be construed as being limited to this embodiment. The exemplary embodiment is directed to a particular application of the present invention, while it will be clear to those skilled in the art that the present invention has applicability beyond the exemplary embodiment set forth herein.

### BRIEF DESCRIPTION OF THE DRAWINGS

In the accompanying drawings, which illustrate an exemplary embodiment of the present invention:

FIG. 1a is a top perspective view of a pipe or stinger according to one exemplary embodiment of the present invention;

FIG. 1b is a detailed side sectional view of the terminal end of the exemplary stinger of FIG. 1a;

FIG. 1c is a side sectional view of the stinger of FIG. 1a;

FIG. 2 is a top perspective view of a pipe support in accordance with the exemplary embodiment of the present invention;

FIG. 3a is a top perspective view of a tank and de-sanding system according to the exemplary embodiment of the present invention

FIG. 3b is a top plan view of the tank and de-sanding system of FIG. 3a;

FIG. 3c is a side elevation view of the tank and de-sanding system of FIG. 3a;

FIG. 3d is a side elevation view of the tank and de-sanding system of FIG. 3a;

FIG. 4 is a detailed side elevation view, partly in section, of a stuffing box in accordance with the exemplary embodiment of the present invention; and

FIG. 5 is a detailed side elevation view, partly in section, of the pipe support in accordance with the exemplary embodiment of the present invention.

FIG. 6 includes perspective, top, side, end and sectional views of the stuffing box.

An exemplary embodiment of the present invention will now be described with reference to the accompanying drawings.

### DETAILED DESCRIPTION OF EXEMPLARY EMBODIMENT

Throughout the following description specific details are set forth in order to provide a more thorough understanding to persons skilled in the art. However, well known elements may not have been shown or described in detail to avoid unnecessarily obscuring the disclosure. The following description is not intended to be exhaustive or to limit the invention to the precise form of any exemplary embodiment. Accordingly, the description and drawings are to be regarded and interpreted in an illustrative, rather than a restrictive, sense.

The present invention is directed to a novel means of mobilizing accumulated solids from a vessel in order to extract the solids from the vessel. While the following description is directed to the specific application of the present invention to de-sanding a heavy oil production storage tank in a SAGD or CHOPS production application, it will be clear to those skilled in the art that the present invention can be employed with numerous other types of vessels in the same and other industries.

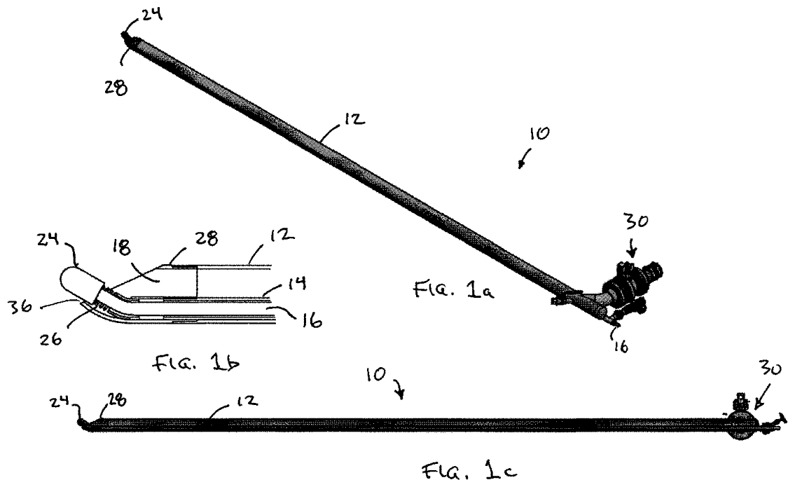

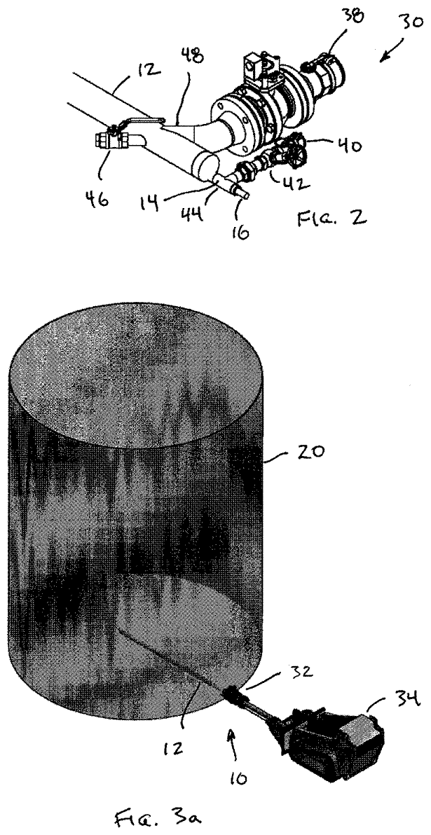

Turning now to FIGS. 1a to 1c, an exemplary liquefying device 10 is illustrated. The device 10 comprises a pipe or stinger 12 and a pipe support 30. The stinger 12 is preferably made of stainless steel, however, it could also be made from carbon steel, exotic steels, various plastics and carbon fiber, of varying diameters, in the judgment of the skilled person knowledgeable in necessary specifications for the described functionality and operating environment. The metal stinger 12 comprises a molded polyurethane end piece 28 which is glued in place using structural adhesive, the end piece 28 providing vibration damping and isolation and also protecting the tank 20 from metal-to-metal contact between the stinger 12 and the tank 20. The stinger 12 is a pipe of sufficient internal diameter to receive a water injection conduit 14 in a lower region thereof, as is best shown in FIG. 1b, while maintaining a passageway in an upper region of the stinger 12 interior as a fluidized materials removal conduit 18, as described below. The specific sizing will be dictated to an extent by the particular application context, and would be determinable within the knowledge of the skilled person.

The water injection conduit 14 is secured against the lower internal surface of the stinger 12 by means of structural adhesive. A vibration shaft 16 is retained within the water injection conduit 14, with enough clearance between the shaft 16 and the conduit 14 internal surface to allow both rotation of the shaft 16 and the flow of water within the conduit 14 around the shaft 16, the injected water leaving the stinger 12 through the water exit 36 adjacent the shaft 16 vibrator head 24. The flexible shaft 16 is preferably a steel braided line, with a protective housing layer that can protect the shaft 16 from debris and contamination while allowing for lubrication. The flexible shaft 16 extends the entire length of the stinger 12, protruding from the terminal end of the stinger 12 at one end and at the pipe support 30 at the other end, as described further below. The shaft 16 is provided with the vibrator head 24 at the terminal end that is intended to be inserted into the tank 20, with an isolation spring 26 immediately behind the vibrator head 24 to isolate the vibration. The shaft 16 is configured to transfer the required energy to the vibrator head 24 from near the pipe support 30, which energy transfer causes the shaft 16 to vibrate and consequently impart such vibration by means of the vibrator head 24 to the solids layer. Note that the shaft 16 may or may not be located within the conduit 14.

FIG. 2 illustrates the exemplary pipe support 30 in greater detail. A water inlet 40 connects to a water source (not shown), and the water is allowed to enter the water injection conduit 14 by means of a ball or gate valve 42, although other valves may be used in the judgment of the skilled person. As can be seen, the flexible shaft 16 protrudes from the water injection conduit 14 through a shaft insertion collar and seal 44, and this protruding end of the shaft 16 will be engaged to rotate the shaft 16. Various means for rotating the shaft 16 will be known to those skilled in the art, such as concrete vibrator drive units (internal combustion engine or electric) which are commercially available and of well-known functionality and operation. An accessory inlet 46 is also provided into the water injection conduit 14, to enable injection of additional water or air as desired; this can also be fitted with a packing gland to allow for insertion of a tool to unclog the support 30 if necessary.

The support 30 also comprises a cam lock connection 38 to a vacuum means (not shown), although other connection means will be obvious to those skilled in the art. As described above, the stinger 12 provides for both injection of water and extraction of liquefied solids. The stinger 12 is provided with a liquefied materials outlet 48 which allows for passage of liquefied solids out of the stinger 12 and through the support 30 toward a disposal unit (not shown). Vacuum means are connected to the cam lock 38 to create a vacuum negative pressure and pull the liquefied solids through the stinger 12 and the support 30 for subsequent disposal.

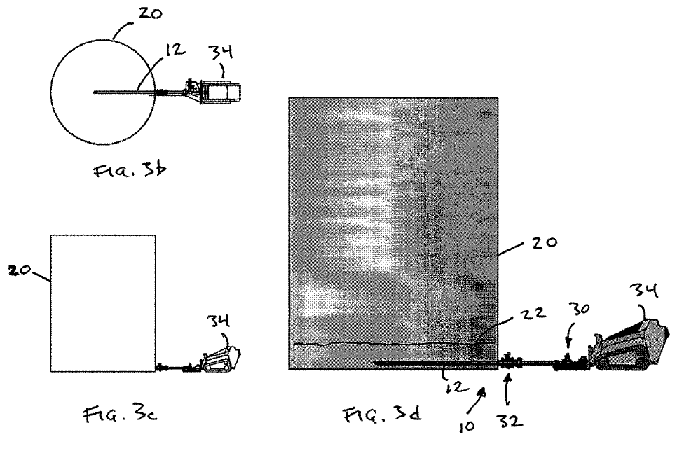

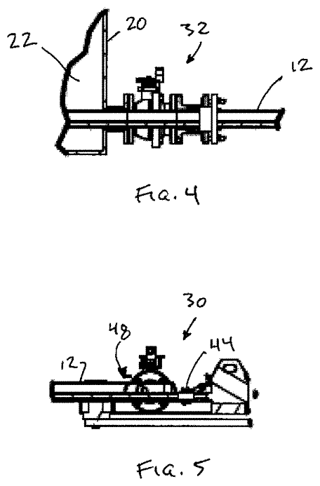

Turning now to FIGS. 3a to 5, the use of the device 10 is further illustrated. As can best be seen in FIGS. 3a and 3d, the device 10 is mounted on a vehicle 34, such as a walk-behind mini-track loader (although the skilled person will know of numerous other vehicles capable of the delivery function), which vehicle 34 can also provide the internal combustion engine, electric or hydraulic power necessary to rotate the shaft 16 as described above. The vehicle 34 is used to position the device 10 and to insert the stinger 12 into the inlet of the tank 20. The tank 20 contains a solids layer 22 which has accumulated therein, and the tank inlet allows access to the solids layer 22.

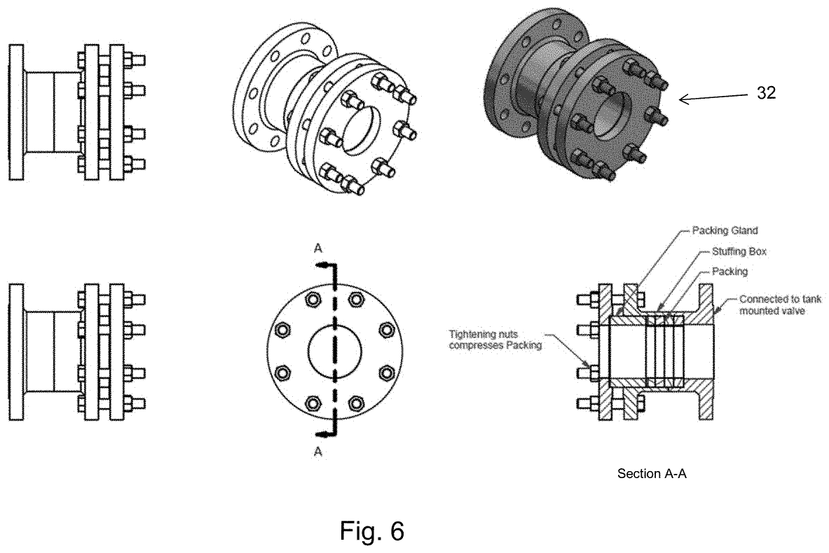

Access to the tank 20 interior is by means of a stuffing box 32, which is shown in detail in FIGS. 4 and 6.

In use, the vehicle 34 would be used to position the device 10 adjacent the tank 20 and to insert the stinger 12 into the tank 20 interior through the stuffing box 32. With the stinger 12 located within the solids layer 22, the operator would begin the injection of water through the pipe support 30 and the water injection conduit 14, and then rotating the shaft 16 to begin imparting vibration to the solids layer 22. With the injection of the water, the vibration works to liquefy the solids layer 22 and render it more mobile. With the solids layer 22 sufficiently liquefied, the vacuum can be engaged to draw the liquefied solids layer 22 into the fluidized materials removal conduit 18 in the stinger 12, and through the liquefied materials outlet 48 and the pipe support 30 to the disposal means. Once the stinger 12 enters the solids layer 22, the vibration commences and a controlled volume of water is introduced into the solids layer 22, and the vacuum is engaged, and these occur simultaneously and throughout the solids extraction process. The extracted high density solids content slurry is then directed to a vacuum tank for storage. Once the vacuum tank reaches a predetermined volume the material is then transferred to a secondary mobile transport unit to be taken to an offsite sand treatment and disposal facility.

Once the solids layer 22 has been sufficiently depleted as desired, the stinger 12 can be removed from the tank 20, the various connections disconnected, and the vehicle 34 used to remove the device 10 from the tank 20 vicinity. Upon successfully depleting the sand layer 22, the flow of controlled water injection will be terminated, the stinger 12 will be removed to the point of the stuffing box 32, the vibration will be terminated, and the valve on the tank 20 will be closed. Vacuum will be engaged, and the stinger 12 and vacuum lines will be emptied. The stuffing box 32 may or may not be removed from the tank 20, and all equipment will be loaded onto its respective vehicle. The vacuum truck will go to disposal.

It will be clear to those skilled in the art that embodiments of the present invention may present numerous advantages over the prior art. For example, the use of vibration and resultant liquefaction may enable the use of a significantly reduced amount of injected water compared to some prior art methods, providing a more dense solids slurry and requiring less process water transportation, which can result in reduced costs. By introducing a controlled but reduced amount of water sufficient to ensure adequate flow to the vacuum truck, the water to sand ratio may be significantly improved. It is possible that only one extraction of sand will be necessary, with no settling time required, as well as removing the water from the vacuum truck back to a tank as in current techniques. This reduction in time required, along with a significantly improved water to sand ratio, may then significantly lower the cost per cubic meter of materials being processed. Also, the stinger, vibrator and controlled water can be used so as to not agitate the sand layer nearly as much as current techniques, thus reducing the further contamination of the water and/or emulsion. Further, less reliance on the operator is required in maintaining an optimal water amount, and the number of personnel may be generally reduced.

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”.
“connected”, “coupled”, or any variant thereof, means any connection or coupling, either direct or indirect, between two or more elements; the coupling or connection between the elements can be physical, logical, or a combination thereof
“herein”, “above”, “below”, and words of similar import, when used to describe this specification shall refer to this specification as a whole and not to any particular portions of this specification.
“or”, in reference to a list of two or more items, covers all of the following interpretations of the word: any of the items in the list, all of the items in the list, and any combination of the items in the list.
the singular forms “a”, “an” and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present) depend on the specific orientation of the apparatus described and illustrated. The subject matter described herein may assume various alternative orientations. Accordingly, these directional terms are not strictly defined and should not be interpreted narrowly.

Where a component (e.g. a circuit, module, assembly, device, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of methods and apparatus have been described herein for purposes of illustration. These are only examples. The technology provided herein can be applied to contexts other than the exemplary contexts described above. Many alterations, modifications, additions, omissions and permutations are possible within the practice of this invention. This invention includes variations on described embodiments that would be apparent to the skilled person, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

The foregoing is considered as illustrative only of the principles of the invention. The scope of the claims should not be limited by the exemplary embodiments set forth in the foregoing, but should be given the broadest interpretation consistent with the specification as a whole.

1. A pipe configured for insertion into a tank to liquefy and remove solids from the tank, the pipe comprising:
a water injection conduit;
a vibrating member configured to impart vibration to the solids, the vibrating member comprising a vibrating head and an energy transfer member, the energy transfer member positioned within the water injection conduit while allowing water to flow around an exterior surface of the energy transfer member, the vibrating head configured for insertion into the solids; and
a fluidized materials removal conduit.

2. The pipe of claim 1, wherein the water injection conduit is disposed within an interior of the pipe and the fluidized materials removal conduit is a portion of the interior of the pipe that is outside the water injection conduit.

3. The pipe of claim 1, wherein the energy transfer member comprises a flexible shaft that is rotated.

4. The pipe of claim 3, wherein the flexible shaft comprises a protective jacket.

5. The pipe of claim 3, wherein rotation of the flexible shaft is achieved by electric or hydraulic means.

6. The pipe of claim 5, wherein the electric or hydraulic means are provided by a positioning implement such as a mini-track loader or other mechanical delivery means.

7. The pipe of claim, 3 wherein the flexible shaft comprises a steel braided line.

8. The pipe of claim 1, wherein the vibrating head extends beyond a terminus of the water injection conduit in order to impart vibration to the solids.

9. The pipe of claim 1, wherein the pipe is at least partially composed of a material selected from the group consisting of stainless steel, carbon steel, exotic steels, plastics and carbon fiber.

10. The pipe of claim 1, and further comprising a polyurethane end piece on an end of the pipe configured for insertion into the solids.

11. The pipe of claim 1, wherein the vibrating member comprises an isolation spring behind the vibrating head.

12. A system for disposal of produced solids comprising:
a vessel for receiving the solids into an interior of the vessel;
a pipe in fluid communication with the solids via a vessel inlet;
a water source for providing water to the pipe for injection into the interior of the vessel interior to form a water-solids slurry;
vibration means positioned within the pipe and configured to impart vibration to and liquefy the water-solids slurry to form a liquefied water-solids slurry; and
vacuum means for extracting the liquefied water-solids slurry through the pipe.

13. The system of claim 12, and further comprising a pipe support for supporting the pipe with respect to the vessel.

14. The system of claim 12, and further comprising a stuffing box to enable engagement of the pipe with the vessel.

15. A method for extracting solids from a vessel comprising the steps of:
inserting a pipe into an interior of the vessel until a terminal end of the pipe is within or adjacent the solids;
injecting water through the pipe into the solids to form a water-solids slurry;
imparting vibration to the water-solids slurry to liquefy the water-solids slurry and form a liquefied water-solids slurry; and
extracting the liquefied water-solids slurry through the pipe.

16. The method of claim 15, wherein the steps of injecting the water, imparting the vibration and extracting the liquefied water-solids slurry occur simultaneously.
